(19) United States
(12) Patent Application Publication
(10) Pub. No.: US 2017/0076082 A1
(43) Pub. Date: Mar. 16, 2017

(54) Identity Verification System and Method

(71) Applicant: Yorid Pty Ltd, North Caulfield, Victoria (AU)

(72) Inventor: Perry ARBER, North Caulfield (AU)

(73) Assignee: Yorid Pty Ltd, North Caulfield, Victoria (AU)

(21) Appl. No.: 15/126,046

(22) PCT Filed: Mar. 12, 2015
(86) PCT No.: PCT/AU2015/000144

§ 371 Date: Sep. 14, 2016

(30) Foreign Application Priority Data
Mar. 14, 2014 (AU) 2014900883

(51) Int. Cl. G06F 21/35; G06F 17/30; G06F 21/62

(52) U.S. Cl. CPC G06F 21/35; G06F 21/6227; G06F 17/30312

(57) ABSTRACT

Disclosed is an identification verification system comprising a verification server arranged to: receive, via a network, user photo data corresponding to a photo of a user upon the user authorising the transmission of the user photo data at an identification data provider system, store user identification data in a verification database, the user identification data including at least the user photo data and corresponding user identification string data indicative of a user identification string, transmit the user identification string data to a user device associated with the user for storage on the user device, and transmit to a merchant device at least the user photo data corresponding to the user identification string upon receiving the user identification string or user identification string data from the merchant device, to enable the merchant device to display the photo of the user on the merchant device. An identification verification method is also disclosed.

### FIELD OF THE INVENTION

The present invention is generally related to identity verification system, and particularly, although not exclusively, related to verification of a user's identity using identity data.

### BACKGROUND TO THE INVENTION

Certain establishments, such as bars, may require that patrons are above a certain age to enter. Traditionally, an employee of such establishments may check a patron's identity document (such as a passport or driver's licence) in order to confirm their age. Usually a photo of the patron is provided on the identity document so that the employee can visually confirm that the identity document belongs to the patron.

However, fraudulent identity documents with fake date-of-birth or other information are readily and cheaply available, for example, over the internet. Patrons using such fraudulent identity documents to illegally enter age-restricted establishments may make it or its employees liable for fines or worse.

Additionally, the employee may be exposed to more information than necessary about the patron upon checking their identity document. For example, the employee may easily observe a patron's name and address, and this information could be used for sinister purposes.

### SUMMARY OF THE INVENTION

In a first broad aspect the invention provides an identification verification system comprising:
a verification server arranged to:
   receive, via a network, user photo data corresponding to a photo of a user upon the user authorising the transmission of the user photo data at an identification data provider system,
   store user identification data in a verification database, the user identification data including at least the user photo data and corresponding user identification string data indicative of a user identification string,
   transmit the user identification string data to a user device associated with the user for storage on the user device, and
   transmit to a merchant device at least the user photo data corresponding to the user identification string upon receiving the user identification string or user identification string data from the merchant device, to enable the merchant device to display the photo of the user on the merchant device.

In an embodiment, the identification string data is generated at the identification data provider system and received at the verification server via the network.

In an embodiment, the verification server is arranged to generate the identification string data.

In an embodiment, the identification string data is transmitted to the user device to enable the user device to display the identification string as an identification token.

In an embodiment, the identification string data is wirelessly transmitted from the user device to the merchant device.

In an embodiment, the wireless transmission is performed via near field communication or radio-frequency identification.

In an embodiment, the user identification data includes additional user data related to a characteristic of the user that is transmitted to the merchant device, for displaying on the merchant device an indication of that characteristic.

In an embodiment, the identification verification system comprises a merchant device wherein the merchant device determines an indication of the characteristic by evaluating a condition.

In an embodiment, the merchant device indicates the characteristic by displaying a colour, shape, image or pattern, making a sound, or vibrating.

In an embodiment, the user identification data includes user date-of-birth data.

In a second broad aspect the invention provides an identification verification method comprising:
receiving, via a network, user photo data corresponding to a photo of a user upon the user authorising the transmission of the user photo data at an identification data provider system,
storing user identification data in a verification database, the user identification data including at least the user photo data and corresponding user identification string data indicative of a user identification string, transmitting the user identification string data to a user device associated with the user for storage on the user device, and
transmitting to a merchant device at least the user photo data corresponding to the user identification string upon receiving the user identification string or user identification string data from the merchant device, to enable the merchant device to display the photo of the user on the merchant device.

In an embodiment, the identification verification method comprises receiving, via the network, the identification string data from the identification data provider system.

In an embodiment, the identification verification method comprises generating identification string data.

In an embodiment, the identification string data is transmitted to the user device to enable the user device to display the identification string as an identification token.

In an embodiment, the identification string data is wirelessly transmitted from the user device to the merchant device.

In an embodiment, the wireless transmission is performed via near field communication or radio-frequency identification.

In an embodiment, the user identification data includes additional user data related to a characteristic of the user that is transmitted to the merchant device, for displaying on the merchant device an indication of that characteristic.

In an embodiment, the merchant device determines an indication of the characteristic by evaluating a condition.

In an embodiment, the merchant device indicates the characteristic by displaying a colour, shape, image or pattern, making a sound, or vibrating.

In an embodiment, the user identification data includes user date-of-birth data.

In a third broad aspect the invention provides computer program code which when executed implements the method of the second broad aspect.

In a fourth broad aspect the invention provides a computer readable medium comprising the computer program code of the third broad aspect.

In a fifth broad aspect the invention provides a merchant device comprising:
an input device arranged to receive a user's identification string data, and
an output device arranged to display the photo of the user,
wherein the merchant device is arranged to transmit the identification string to an identification verification system, and to receive from the identification verification system identification data corresponding to the user and including at least photo data corresponding to a photo of the user.

In an embodiment, the input device is a scanner arranged to receive an identification token that corresponds to the user's identification string data, and wherein the merchant device is arranged to decode the identification token to extract the user's corresponding identification string.

In an embodiment, the input device receives the user's identification string data wirelessly.

In an embodiment, the user's identification string data is received via near field communication or radio-frequency identification.

In an embodiment, the merchant device receives identification data including additional user data related to a characteristic of the user, and wherein the output device is arranged to display an indication of that characteristic.

In an embodiment, the processor determines an indication of the characteristic by evaluating a condition.

In an embodiment, the output device indicates the characteristic by displaying a colour, shape, image or pattern, making a sound, or vibrating.

In a sixth broad aspect the invention provides an identification verification method comprising:
receiving a user's identification string data,
transmitting the identification string data to an identification verification system,
receiving from the identification verification system identification data corresponding to the user and including at least photo data corresponding to a photo of the user,
displaying the photo of the user.

In an embodiment, receiving the user's identification string data includes scanning an identification token that corresponds to the user's identification string data and decoding the identification token to extract the user's corresponding identification string.

In an embodiment, the user's identification string data is received wirelessly.

In an embodiment, the user's identification string data is received via near field communication or radio-frequency identification.

In an embodiment, the identification data includes additional user data related to a characteristic of the user, and displaying an indication of that characteristic.

In an embodiment, the identification verification method comprises evaluating a condition to determine an indication of the characteristic.

In an embodiment, the identification verification method comprises indicating the characteristic by displaying a colour, shape, image or pattern, making a sound, or vibrating.

In a seventh broad aspect the invention provides computer program code which when executed implements the method of the sixth broad aspect.

In an eighth broad aspect the invention provides a computer readable medium comprising the computer program code of the seventh broad aspect.

In a ninth broad aspect the invention provides an identification verification system comprising:
a verification server arranged to:
   receive user photo data corresponding to a photo of a user upon the user from an identification data provider, and
   store the user photo data in a user device associated with the user,
an input device arranged to receive the user photo data from the user device, and
a display device arranged to display the photo of the user upon receiving the user photo data from the user device at the input device.

In a tenth broad aspect the invention provides an identification verification method comprising:
receiving user photo data corresponding to a photo of a user upon the user from an identification data provider,
storing the user photo data in a user device associated with the user,
receiving the user photo data from the user device at an input device, and
displaying the photo of the user upon receiving the user photo data from the user device at the input device.

### BRIEF DESCRIPTION OF THE DRAWINGS

In order that the invention may be more clearly ascertained, embodiments will now be described, by way of example, with reference to the accompanying drawing, in which:

FIG. 1 is a block diagram of an identification verification system of an embodiment of the invention,

FIG. 2 is a user device that communicates with the identification verification system of FIG. 1,

FIG. 3 is an online portal of an identification data provider system that communicates with the identification verification system of FIG. 1,

FIG. 4a is a representation of user identification data stored in a database of the identification verification system of FIG. 1,

FIG. 4b is a representation of user identification data stored in a database of the identification verification system of FIG. 1 including indications as to other user characteristics,

FIG. 5 is the user device of FIG. 2 displaying an identification token,

FIG. 6 is a flow diagram of a merchant gaining access to the identification verification system of FIG. 1,

FIG. 7 is a flow diagram of a merchant using the identification verification system of FIG. 1,

FIGS. 8a and 8b are merchant devices displaying a photo of a user and a corresponding characteristic of the user,

FIG. 9 is a boarding pass showing an identification token used by the identification verification system of FIG. 1,

FIG. 10 is a smartphone boarding pass showing an identification token used by the identification verification system of FIG. 1, and

FIG. 11 is a credit card showing a CSC according to the prior art.

### DETAILED DESCRIPTION OF EMBODIMENTS OF THE INVENTION

The invention is generally related to an identification verification system and method in which: i) a user can register with an identification data provider in order to receive a unique identification string and to provide an identification token indicative of that string to a merchant, and ii) a merchant can register with the identification verification system in order to scan the user's identification token to receive a photo of the user and an indication of a status, for identification purposes.

In this specification, the word “user” or variations such as “users” refers to a person or individual who registers with the identification verification system. In this specification, the word “merchant” or variations such as “merchants” refers to a person, organisation or representatives thereof (such as employees) who use the identification verification system to verify the identification of a user.

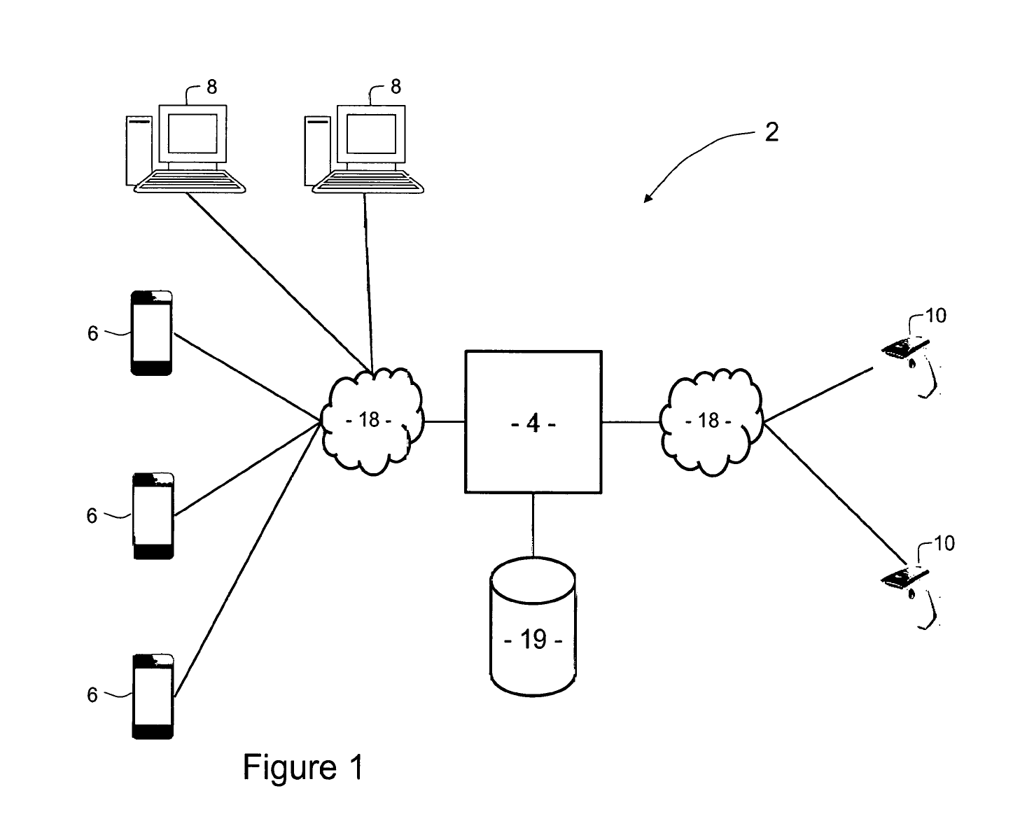

Referring to FIG. 1, the identification verification system 2 is typically provided and administered by a system provider or administrator. The identification verification system 2 comprises a verification server 4 arranged to communicate with various third party systems in order to allow a merchant to verify the identity and other characteristics of a user (such as age), where the user is not required to produce an identity document such as a passport or driver's licence. The verification server 4 is typically arranged to communicate with one or more of each of user devices 6, identification data provider systems 8, and merchant devices 10.

Generally, a user registers with the identification verification system 2 in order to receive an identification string for storage on their device 6. The identification string can be displayed as an identification token on a user device 6, for scanning by a merchant using a merchant device 10. Alternatively, the identification string can be transmitted to a merchant device via a wireless communication chip, such as a near field communication (NFC) chip or a radio-frequency identification (RFID) chip.

In some embodiments, a user device 6 is arranged to display a user's identification string as an identification token in a suitable format for scanning by a merchant device 10. For example, the identification token may be displayed on a user device 6 as a barcode, QR code, or in any other suitable format. Typically, the user device 6 may be a smartphone or any other suitable device that, for example, displays the identification token on a screen. However, in other embodiments the user device 6 may simply be a print out of the identification token in a suitable format. The merchant device 10 is typically arranged to scan a user's identification token and to display a photo associated with the identification token and to indicate a characteristic (such as the user's age) to the merchant. In other embodiments, the identification string may be stored in the user device 6 for transmission to a merchant device 10 via wireless communication chip, such as a NFC chip or a RFID chip.

For example, a merchant may wish or be legally required to verify a person's age or other characteristic before providing them with a product or service. A merchant may run a bar or nightclub in which patronage is restricted to people over a certain age, such as 18 or 21. Traditionally, a bouncer at the door may ask for and inspect a suitable identity document, such as a passport or driver's licence, before permitting entrance to the bar. In inspecting the identity document, the bouncer (or merchant) may visually verify that the identity-document photo is of the patron, and that the listed identity-document date of birth makes the person the same as or older than the required age. However, in handing over a suitable identity document, a person may unnecessarily expose additional information to the bouncer, such as their name, identification string, address or contact information (depending on the nature of the identity document). The identification verification system 2 may be advantageous in that it provides a system in which no unnecessary information is provided to the merchant, and in which a user need not necessarily carry an identifier card separately from their user device 6. The identification verification system 2 may be advantageous in that it can protect the privacy of its users.

Typically, an identification data provider is an organisation that is responsible for administrating and providing identity documents to people, such as certain government departments. For example, VicRoads (or the Roads Corporation of Victoria) is an Australian statutory corporation which is the state road and traffic authority in the state of Victoria, Australia, and which is responsible for state driver licensing. VicRoads may collect or generate information about people (including a user's photo, name, address, date of birth and licence number) in order to issue them with a Victorian driver's licence, which may be used as a form of identification, for example, when entering a bar. (Similarly, the Department of Foreign Affairs and Trade of Australia may collect or generate similar information in order to issue users with an Australian passport). Such information is typically stored in an identification data provider database (not shown).

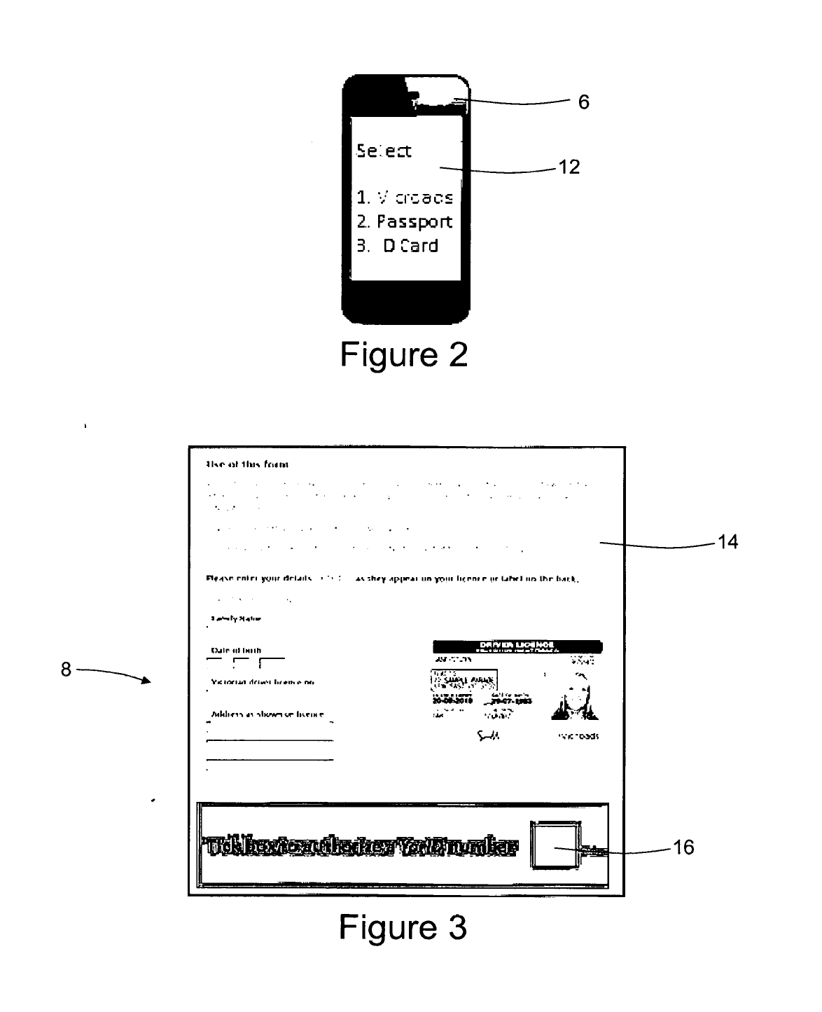

Referring to FIGS. 1 to 3, a user who wishes to use the identification verification system 2 may sign up or register via a third party identification data provider system 8. In doing so, the user may download a suitable user application 12 to their user device 6 that controls the user device to: i) communicate with and receive data from the identification verification system 2, and ii) display an identification token based on the identification string upon a user command (after successful registration). However, communication of the identification string and display of the associated identification token may be executed in any suitable manner.

A user may access an identification data provider system 8, for example by using a computer to log into an associated online portal 14, in order to authorise the creation of a unique identification string. For example, the online portal 14 may provide a checkbox 16 that, upon checking, causes a unique identification string to be generated and transmitted to the identification verification system 2. Alternatively, the identification data provider system 8 may indicate the authorisation to the identification verification system 2, which is arranged to generate the unique identification string locally. However, the identification string may be generated at any suitable location. In an exemplary embodiment, the identification data provider system 8 also anteriorly, concurrently or subsequently transmits data indicative of the user's photo and date of birth, which is taken from the identification data provider database. However, in other embodiments, any suitable data (such as name data or address data) may be transmitted from the identification data provider system 8 to the identification verification system 2. In some embodiments, the user may be required to select their intended identification data provider from a list displayed in the user application 12. The content of such a list is typically dictated by the identification data providers with which the identification verification system 2 administrator has a relationship.

The invention may be advantageous in that it is difficult for a user or other party to modify or tamper with user information, such as user date-of-birth information, thereby preventing the creation of fraudulent identification documents.

Referring to FIG. 1, the identification data provider system 8 typically communicates with or transmits data to the identification verification system 2 via a wired or wireless network 18 such as the internet, a local area network (LAN), a wide area network (WAN), or any other suitable network. The identification verification system 2 is arranged to store the received data, for example, in a local or remote verification database 19. The verification database 19 may use cloud-based or internet-based data storage services. The identification verification system 2 is typically implemented using software but alternatively may be implemented using hardware or a combination of software and hardware. The identification verification system 2 may be implemented using any suitable computer program code or any suitable programming language. The computer program code may be stored on a computer readable medium such a hard disk drive (HDD) or random access memory (RAM).

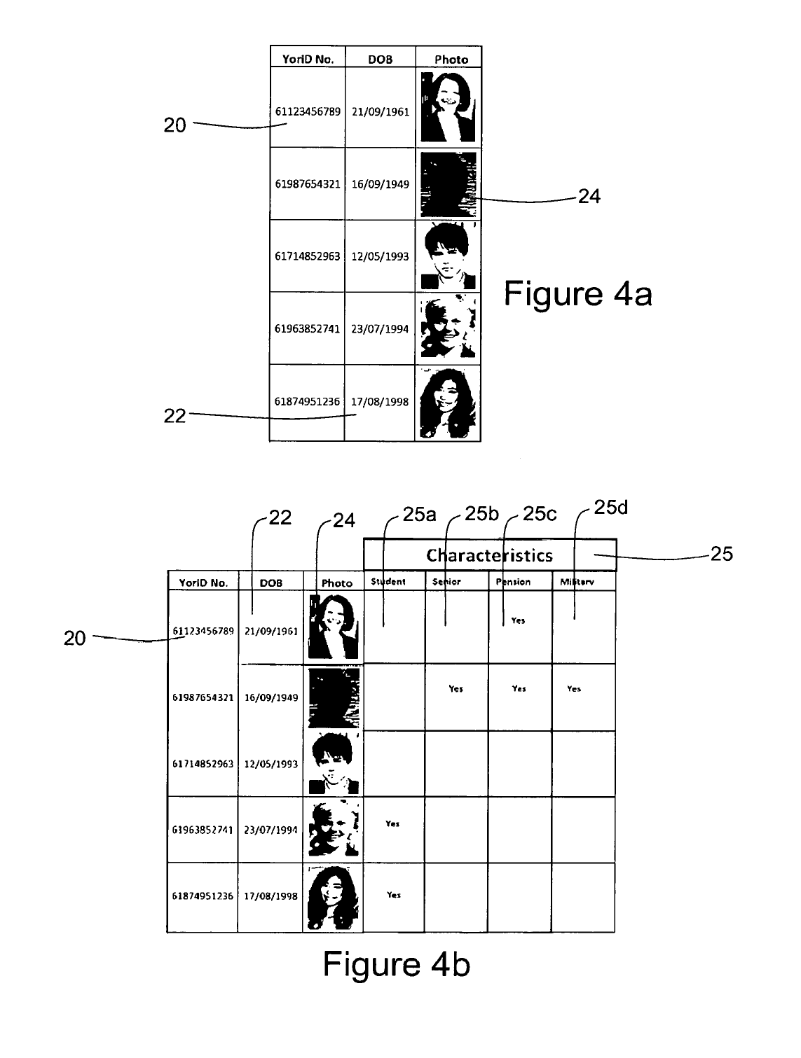

Referring to FIG. 4a, in an embodiment, the identification verification system stores for each registered user: i) unique identification-string data 20 that is indicative of the user's identification string, ii) date-of-birth data 22 that is indicative of the user's date of birth, and iii) photo data 24 that is inductive of a photo of the user. However, referring to FIG. 4b, in other embodiments, the identification verification system 2 may receive and store any suitable data, information or other characteristics 25, such as a user's name, address, licence number, nationality, or gender. The other characteristics 25 may also include an indication as to whether a user is a student 25a, is a senior citizen 25b, is a pensioner 25c, is military 25d or ex-military, has a specific health issue, is a problem gambler, or any other suitable status.

A user's identification string may be generated at the identification data provider system, the identification verification system, or in any other suitable location. In an embodiment, the identification string is a 16 digit number wherein: i) the first three digits represent the country of the identification data provider (for example, USA=001, Australia=002, etc), ii) the fourth digit represents the identity document issuing authority (for example, customs=1, transport authority=2, etc), iii) the fifth to fifteenth digits are randomly generated, generated based on time, generated based on location, or generated as a combination thereof or in any other suitable manner, and iv) the sixteenth digit is a check digit. However, any suitable identification string may be generated or created in any suitable manner, so long as the resulting identification string is unique when compared with other users' identification strings stored in the identification verification system. For example, the identification string may use any suitable combination of numbers, letters, symbols, control characters, non-printing characters and spaces.

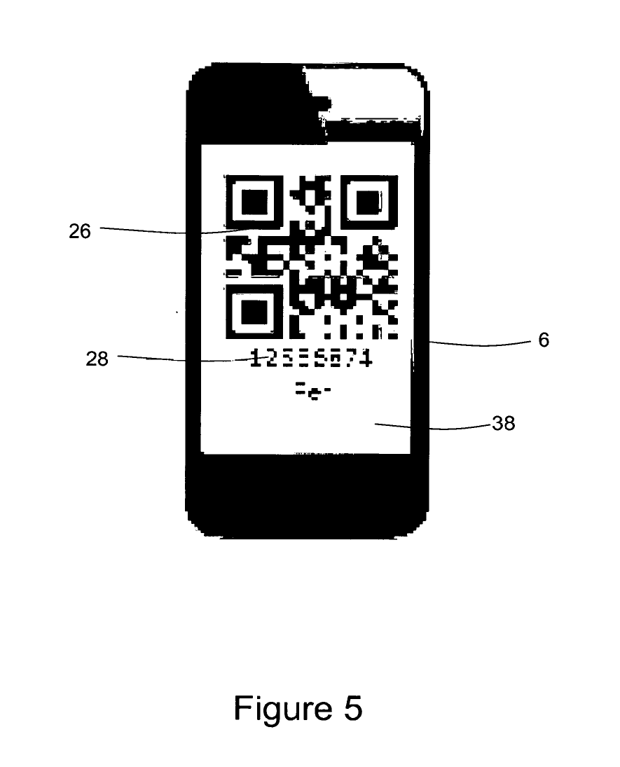

Referring to FIGS. 1 and 5, a user's identification string is communicated or transmitted to that user's device 6 upon the generation and storage of the identification string in the identification verification system 2. In some embodiments, a user's identification string is transmitted from the identification verification system 2 to a user device 6 via a network 18. The user device 6 is arranged to display, for example on its screen 38, an identification token 26 that is indicative of the user's identification string 28. In particular, the application may display the identification token 26, though this may be done in any other suitable manner, such as by displaying an image file of the identification token 26. The user device 6 may also display the identification string 28 in text form. The user device 6 or application may render the identification token 26 based on the identification string 28, for example, as a QR code, barcode or in any other suitable format. Alternatively, the identification token 26 may be rendered at the identification verification system 2 or identification data provider system 8 and sent to the user device 6 (rather than sending the identification string 28). In some embodiments, the identification token 26 may be represented by the identification string 28 in plain text. A single user device 6 may be arranged to display or store multiple identification tokens 26 or strings 28 corresponding to respective multiple users.

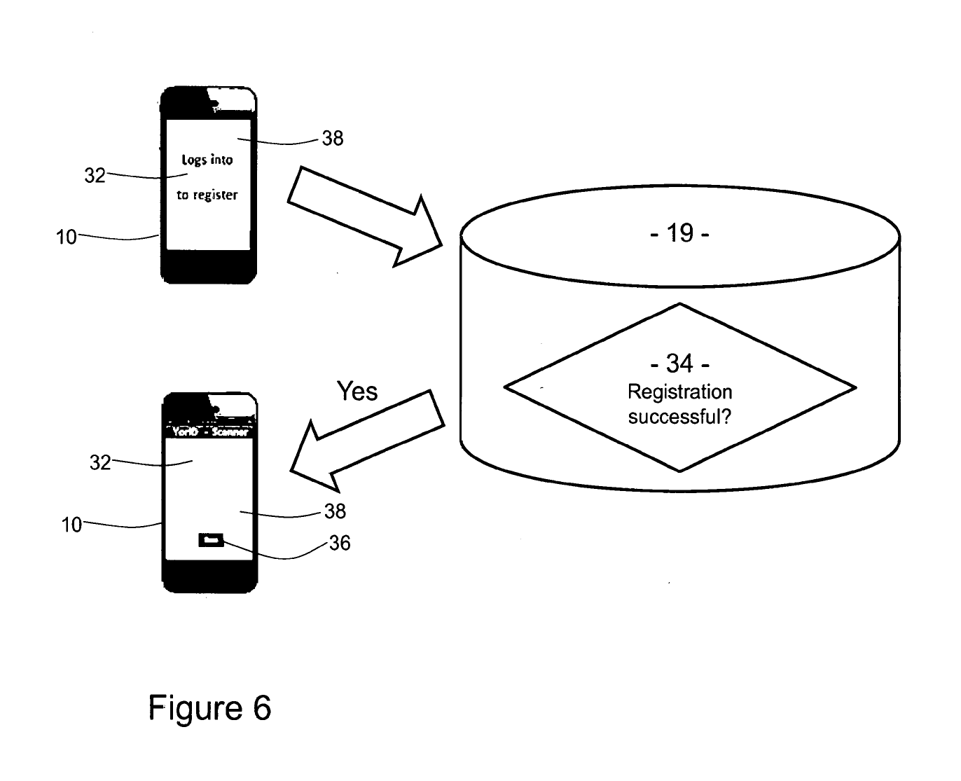

Referring to FIGS. 1 and 6, a merchant may sign up to or register for the identification verification system 2 in order to use it in verifying the identification of users. In doing so, the merchant may download a suitable merchant application 32 to a merchant device 10 that enables the registration of an account with the identification verification system 2. Alternatively, the merchant may register an account on a computer such as a laptop or tablet, or in any other suitable manner. The merchant may be required to pay a fee in order to register an account with the identification verification system 2. The merchant may also need to prove that they are required or authorised to verify the identities of users. Upon successful registration 34, the identification verification system 2 may store a record of the merchant in the verification database 19, a separate dedicated merchant database (not shown), or in any other suitable manner. In some embodiments, each merchant device 10 used by a particular merchant must be individually registered in order to access the identification data (though each device 10 may be registered or associated with the same merchant account).

A merchant, upon registering with the identification verification system 2, may be granted access to specific user data. For example, a casino that has been registered as a merchant may be granted access to identification data that includes a user's photo, date of birth, and an indication as to whether the user is a problem gambler; a tobacco merchant would typically not be granted access to problem gambling data.

Once registered, the merchant may be granted access to scanning functionality provided 36 by the merchant application 32, as well as access to the user data stored in the identification verification system 2 via a merchant device 10. A merchant device 10 typically comprises three components: i) an input device, ii) an output device, and iii) a processor. In some embodiments, the input device is a scanner that is arranged to scan a proffered user's identification token so that the merchant device 10 can (for example, using the processor) extract or identify the corresponding identification string, for example, by decoding a QR code. In other embodiments, the input device is a is a wireless communication chip (such as a NFC chip or a RFID reader) that is arranged to wirelessly receive a user's identification string from a NFC or RFID chip in a user's device. In embodiments where the identification token is represented by the identification string in plain text, the merchant device may execute optical character recognition in identifying the identification string. However, the merchant device 10 may decode, detect or extract the identification string in any suitable manner.

The output device is arranged to indicate information corresponding to the identification string to the merchant. In an exemplary embodiment, the output device is a screen 38, but the output device may be any suitable device, such as a speaker or a combination of a speaker and a screen 38. The merchant device 10 may be an integral or non-integral combination of the Scanner and output device. In some embodiments, the merchant device 10 is a smartphone, the scanner is an integral camera, and the output device is an integral screen 38. In other embodiments the merchant device 10 may comprise a handheld scanner connected to a separate screen via a computer or processor. However, any suitable merchant device 10 may be provided.

A merchant device 10 may communicate with the identification verification system 2 over a network 18 or in any other suitable manner. In embodiments where the merchant device 10 is a smartphone, the merchant device 10 may communicate directly with the identification verification system 2 via a cellular network, or indirectly via Wi-Fi to a merchant computer and via a VPN and the internet to the identification verification system 2. In some embodiments, access to the identification verification system 2 may only be provided to the merchant device 10 if the merchant application 32 is used, whether installed on a merchant smartphone, a merchant computer, or some other suitable merchant system.

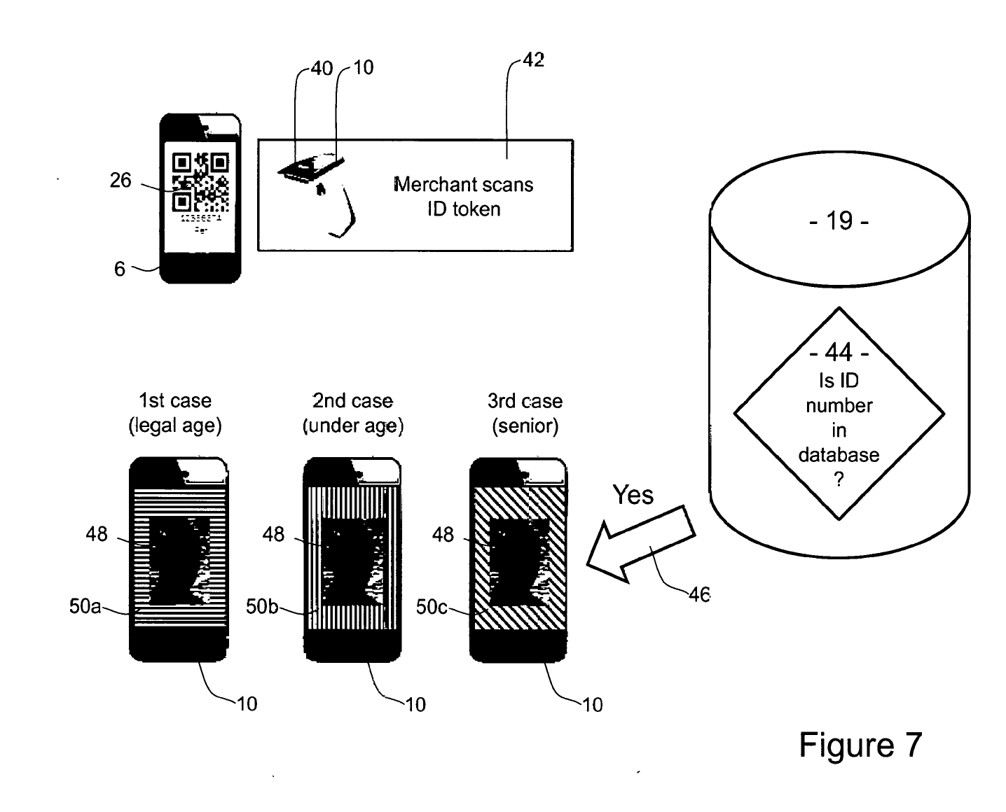

Referring to FIGS. 1 and 7, a merchant may use a merchant device 10 to scan an identification token 28 presented by a user in order to verify their identity, for example, to allow them entry to a restricted premise. The user may present their identification token 28, for example, displayed on a screen of a user device 6. The merchant may use the scanner 40 of their merchant device 10 to scan 42 the proffered identification token 28. Upon scanning, the merchant device 10 may process the identification token 28 to decode or recognise and thereby extract or derive the corresponding identification string.

The merchant device 10 (which typically has access to the information data stored in the identification verification system 2) then directly or indirectly communicates with the identification verification system 2 in order to verify 44 whether the identification string is stored therein. For example, the merchant device 10 may transmit an encrypted or unencrypted message including the identification string to the identification verification system 2. Upon receipt, the identification verification system 2 may decrypt the message (if necessary) and search the verification database 19 for the received identification string. The identification verification system 2 may then: i) transmit a message including the associated user-identity data (such as date of birth and photo data) if a corresponding identification string is found 46, or ii) transmit an error message if a corresponding identification string is not found.

Generally, the merchant device 10 is arranged to: i) display to the merchant a photo 48 of a user based on user-photo data received from the identification verification system 2, for visual facial recognition by the merchant, and ii) indicate to the merchant some characteristic associated with the received identification data, for decision making by the merchant based on that indication. The merchant device 10 is typically arranged to process the received identity data in order to select and output one of a set of different indicators based on a calculated condition.

In the example given below, it is assumed that a merchant: i) owns and operates a bar in which entry is only permitted to people over the age of 18, ii) is registered with the identification verification system 2, and iii) owns or has access to one or more merchant devices 10. It is also assumed that a user who wishes to gain entry to the bar has also registered with the identification verification system 2 and owns a user device 6 that is arranged to display their identification token 28.

In the first case of this example, the user is between the ages of 18 and 65, and so should be permitted to enter the bar. The user presents their identification token 28, which is scanned by the merchant. The merchant device 10 receives the user's identity data from the identification verification system 2. Firstly, the merchant device 10 uses the user-photo data to display a photo 48 of the user on its screen 38, so that the merchant can visually compare the photo 48 of the user to the actual user. The merchant can decide whether the photo 48 matches the user, and deny entry if not. Secondly, the merchant device 10 uses the date-of-birth data to calculate the age of the user, for example, by subtracting the date of birth from the known current date. The merchant device 10 then evaluates whether a condition is met based on the calculated age. In particular in this case, the merchant device 10 evaluates that the user's age (i.e. 18 to 65) is greater than or equal to the required age (i.e. 18), and indicates the same to the merchant. In an embodiment, the merchant device 10 indicates that the user is 18 or older by displaying a coloured border 50a around the photo 48. The border 50a may be green, which is represented by horizontal lines in FIG. 7. The merchant, upon observing the green border 50a, determines that the user is of a legal age and may be permitted entry to the bar.

In the second case of this example, the user is under the age of 18, and so should be denied entry the bar. The user presents their device 6, which has an installed RFID chip and identification string data stored thereon, and which is scanned by the merchant. The merchant device 10 receives the user's identity data from the identification verification system 2.

Firstly, the merchant device 10 uses the user-photo data to display a photo 48 of the user on its screen 38, so that the merchant can visually compare the photo 48 of the user to the actual user. The merchant can decide whether the photo 48 matches the user (which may be a moot point, in this case). Secondly, the merchant device 10 uses the date-of-birth data to calculate the age of the user, for example, by subtracting the date of birth from the known current date. The merchant device 10 then evaluates whether a condition is met based on the calculated age. In particular in this case, the merchant device 10 evaluates that the user's age (i.e. under 18) is lesser than the required age (i.e. 18), and indicates the same to the merchant. The merchant device 10 indicates that the user is under 18 by displaying a coloured border 50b around the photo 48. The border 50b may be red, which is represented by vertical lines in FIG. 7. The merchant, upon observing the red border 50b, determines that the user is under the legal age and should be denied entry to the bar.

In the third case of this example, the user is over the age of 65, and so should be permitted to enter the bar, but should also be recognised as a senior. The user presents their identification token via NFC connectivity 28, which is scanned by the merchant. The merchant device 10 receives the user's identity data from the identification verification system 2. Firstly, the merchant device 10 uses the user-photo data to display a photo 48 of the user on its screen 38, so that the merchant can visually compare the photo 48 of the user to the actual user. The merchant can decide whether the photo 48 matches the user, and deny entry if not. Secondly, the merchant device 10 uses the date-of-birth data to calculate the age of the user, for example, by subtracting the date of birth from the known current date. The merchant device 10 then evaluates whether a condition is met based on the calculated age. In particular in this case, the merchant device 10 evaluates that the user's age (i.e. over 65) is greater than or equal to the required age (i.e. 18), and indicates the same to the merchant.

The merchant device 10 indicates that the user is a senior (and inherently 18 or older) by displaying a coloured border 50c around the photo 48. The border 50c may be yellow or orange, which is represented by diagonal lines in FIG. 7. The merchant, upon observing the yellow or orange border 50c, determines that the user is a senior and may be permitted entry to the bar.

The merchant device 10 may indicate the evaluated condition, for example the age of the user, in any suitable manner. In an embodiment, the merchant device 10 displays a coloured border 50 around the user's photo 48, where the colour of the border indicates the evaluated condition. Alternatively or additionally, the merchant device 10 may display a pattern, a shape, or an image, or make a sound or vibrate to indicate the evaluated condition to the merchant. For example, the merchant device 10 may display a tick or a cross to indicate that a user is of age or not-of age respectively. The merchant device 10 may indicate the evaluated condition by using any suitable combination of a displayed colour, pattern, shape and image and making a sound and vibrating, or in any other suitable manner.

The invention may be advantageous in that only the information required by the merchant is presented, and additional information that may be transmitted using traditional identification or ‘carding’ methods, such as a user's name and address, is withheld. It is noted that the user photo displayed to the merchant is the same as the photo that may be found on a traditional identity document, but it may be displayed in a larger and higher resolution format (depending on the data received from the identification data provider).

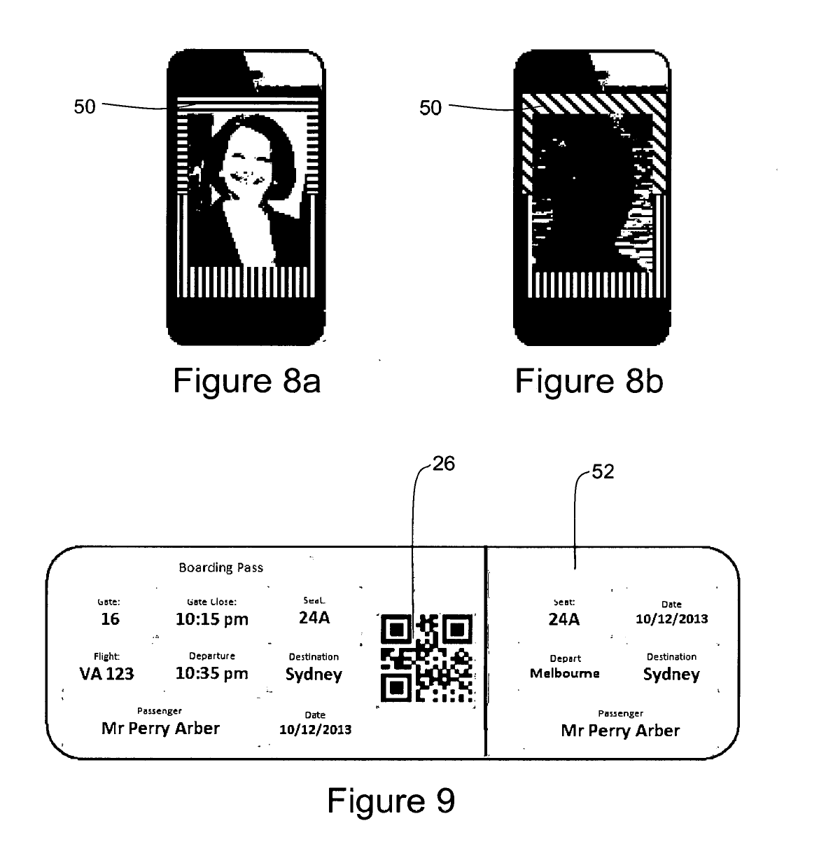

Referring to FIG. 8, the merchant device 10 may be arranged to output an indicator that indicates a combination of two or more conditions or restrictions. For example, in FIG. 8a, the top half of the coloured border 50 is be green (represented by horizontal lines) and the bottom half of the coloured border 50 is red (represented by vertical lines), which may indicate to a merchant that the user is of the legal age but some restrictions apply. For example, in FIG. 8b, the top half of the coloured border 50 is be orange or yellow (represented by diagonal lines) and the bottom half of the coloured border 50 is red (represented by vertical lines), which may indicate to a merchant that the user is a senior but some restrictions apply. Such restrictions may relate to problem gamblers or alcoholics, where such identifiers can assist in merchants providing suitable facilities for a user.

The identification verification system may be applied in other areas or industries that require the identification of users, as detailed below. For example, those who are addicted to or abuse heroin or other opioids may be given access to state-dispensed methadone. Presently, there are problems in tracking the effectiveness in methadone as a substance abuse treatment. A methadone clinic may be able to use the identification verification system to track dispensation of state-sponsored methadone. For example, a methadone user's identification string may be given to a doctor who can prescribe methadone. The methadone user's identification token may be printed on the prescription, along with the doctor's identification. Upon presentation, a dispensing chemist (i.e. merchant) can scan the identification token so that the user's photo is displayed for visual identification, and ultimately dispensation of the methadone. The identification verification system 2 (or a local methadone clinic or central health service system) may be arranged to record and track instances of individual users receiving doses over time, as well as preventing individual users from receiving higher or more frequent doses than necessary or permitted. This system may be advantageous in that a prescription can be issued at any appropriate premises (rather than a specific doctor's office), and the prescription can't be sold because the purchaser of such would fail the photo identification test.

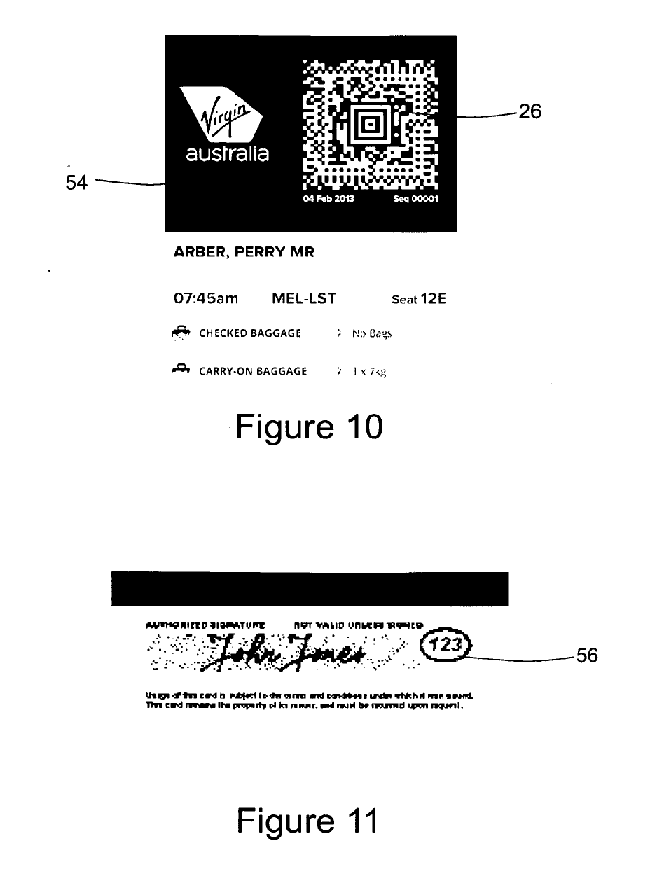

Referring to FIG. 9, as another example, the identification verification system may be used by airlines to ensure a passenger boarding a plane is the person listed on the boarding pass 52. Traditional boarding passes for domestic flights usually include a barcode that is scanned at the gate, but no photo verification of the passenger is undertaken. In an embodiment, a user's identification token 26 may be printed on the boarding pass 52 and presented at the gate for scanning. Upon scanning, a photo of the user may be displayed for visual identification of the passenger. Referring to FIG. 10, an identification token 26 may similarly be displayed on a smartphone boarding pass 54. This system may be also be used when checking passengers on international flights, in which case passports are typically checked at the gate. This system may be advantageous in that there is higher confidence that the passenger travelling is the named passenger on the boarding pass, so that transfers aren't available, which may save an airline money. This system may also provide a deterrent to potential terrorists because their photo is saved on the airline systems.

As another example, the identification verification system 2 may be used in several applications in banking. In a first application, a merchant (i.e. a bank) and a user (i.e. a customer) may register with the identification verification system. In some embodiments, the merchant has a merchant server that stores its specific customer-user identity data. In such embodiments, the user can notify the bank of its registration (for example, by showing an identity token or string), and the bank can request that the identification verification system transmits the corresponding identity data for local storage. In other embodiments, the merchant has access to user identity data directly from the identification verification system. In this example, the identification data may include additional user account information, though such information may be linked by the bank at a later time.

In making a banking transaction, a user may enter a bank and present their identification token for scanning by the merchant (such as a teller). The merchant device displays the user's photo for visual identification of the user. The merchant device may also display the usual banking system interface including, for example, any accounts associated with that user, so that the merchant can assist the user with their required transactions.

In a second application, data indicative of a user's identification string or token may be embedded in the chip of a smart card, such as a credit or debit card. In making a credit or debit card purchase at, for example, a retail merchant, a user may insert their card into a card reader or wave it past a contactless payment system. Traditionally, the merchant requests that the user signs a receipt, and checks the signature with that on the card to ensure that the user owns the card. However, in these embodiments, the merchant device (which may include the card reader) is arranged to display the user photo (from data contained on the chip) so that the merchant can visually confirm the identity of the user. This may be advantageous in that it prevents fraudulent activity.

In a third application and referring to FIG. 11, in some embodiments, a user's identification string may be used to authorise online or over-the-phone credit or debit card purchases. Traditionally online or over-the-phone credit or debit card purchases are authorised by using a card security code (CSC) or card code verification (CVV) 56. In these embodiments, merchants may request that the user provides certain digits taken from their identification string, such as the last four digits, rather than the CSC. This may be advantageous in that the required identification string digits are not printed on the card, and so are less susceptible to fraud should another party have physical access to a user's card.

It will be understood to persons skilled in the art of the invention that many modifications may be made without departing from the spirit and scope of the invention.

In the claims that follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such reference does not constitute an admission that such prior art forms a part of the common general knowledge in the art, in Australia or any other country.

1-40. (canceled)

41. A verification server arranged to:
receive, via a network, user photo data corresponding to a photo of a user upon the user authorising the transmission of the user photo data at an identification data provider system,
store user identification data in a verification database, the user identification data including at least the user photo data, additional user data related to a characteristic of the user, and corresponding user identification string data indicative of a user identification string,
transmit the user identification string data to a user device associated with the user for storage on the user device, to enable the user device to output the identification string as an identification token,
receive the user identification string or user identification string data from the merchant device, upon the merchant device decoding the identification token to extract the user identification string, and
transmit to the merchant device at least the user photo data and the additional user data corresponding to the user identification string, to enable the merchant device to display the photo of the user and an indication of the characteristic of the user on the merchant device,
wherein the merchant device determines the indication of the characteristic by evaluating a condition, and indicates the characteristic by displaying a colour, shape, image or pattern, making a sound, or vibrating.

42. An identification verification system comprising a verification server as claimed in claim 41.

43. An identification verification system as claimed in claim 42, wherein the identification string data is generated at the identification data provider system and received at the verification server via the network.

44. An identification verification system as claimed in claim 42, wherein the verification server is arranged to generate the identification string data.

45. An identification verification system as claimed in claim 42, wherein the user device outputs the identification token by displaying the identification token.

46. An identification verification system as claimed in claim 42, wherein the user device outputs the identification token by wireless transmission.

47. An identification verification system as claimed in claim 46, wherein the wireless transmission is performed via near field communication or radio-frequency identification.

48. An identification verification system as claimed in claim 42, wherein the user identification data includes user date-of-birth data.

49. An identification verification method comprising:
receiving, via a network, user photo data corresponding to a photo of a user upon the user authorising the transmission of the user photo data at an identification data provider system,
storing user identification data in a verification database, the user identification data including at least the user photo data, additional user data related to a characteristic of the user, and corresponding user identification string data indicative of a user identification string,
transmitting the user identification string data to a user device associated with the user for storage on the user device, to enable the user device to output the identification string as an identification token,
receiving the user identification string or user identification string data from the merchant device, upon the merchant device decoding the identification token to extract the user identification string, and
transmitting to the merchant device at least the user photo data and the additional user data corresponding to the user identification string, to enable the merchant device to display the photo of the user and an indication of the characteristic of the user on the merchant device,
wherein the indication of the characteristic is determined by the merchant device by evaluating a condition, and the characteristic is indicated by the merchant device by displaying a colour, shape, image or pattern, making a sound, or vibrating.

50. An identification verification method as claimed in claim 49, comprising receiving, via the network, the identification string data from the identification data provider system.

51. An identification verification method as claimed in claim 49, comprising generating identification string data.

52. An identification verification method as claimed in claim 49, wherein the user device outputs the identification token by displaying the identification token.

53. An identification verification method as claimed in claim 49, wherein the user device outputs the identification token by wireless transmission.

54. An identification verification method as claimed in claim 53, wherein the wireless transmission is performed via near field communication or radio-frequency identification.

55. An identification verification method as claimed in claim 49, wherein the user identification data includes user date-of-birth data.

56. A non-transitory computer readable medium comprising computer program code which when executed implements the method of claim 49.

57. A merchant device comprising:
an input device arranged to receive an identification token output by a user device and corresponding to a user's identification string data, and
an output device arranged to display a photo of the user and an indication of a characteristic of the user, the characteristic being indicated by displaying a colour, shape, image or pattern, making a sound, or vibrating,
wherein the merchant device is arranged to:
decode the identification token to extract the user's corresponding identification string,
transmit the identification string or identification string data to an identification verification system,
receive from the identification verification system identification data corresponding to the user and including at least photo data corresponding to the photo of the user and additional user data related to the characteristic of the user, and determine the indication of the characteristic by evaluating a condition, to enable the output device to display the photo of the user and the indication of the characteristic.

58. A merchant device as claimed in claim 57, wherein the input device is a scanner.

59. A merchant device as claimed in claim 57, wherein the identification token is output by the user device by wireless transmission.

60. A merchant device as claimed in claim 59, wherein the wireless transmission is performed via near field communication or radio-frequency identification,
